(19) United States
(12) Patent Application Publication
(10) Pub. No.: US 2024/0416310 A1
(43) Pub. Date: Dec. 19, 2024

(54) REACTOR WITH ELECTRICALLY HEATED THERMO-CONDUCTIVE STRUCTURE FOR ENDOTHERMIC CATALYTIC PROCESSES

(71) Applicant: POLITECNICO DI MILANO, Milano (IT)

(72) Inventors: Matteo AMBROSETTI, Miradolo Terme (IT); Alessandra BERETTA, Milano (IT); Gianpiero GROPPI, Segrate (IT); Matteo Carmelo ROMANO, Piacenza (IT); Enrico TRONCONI, Arcore (IT)

(73) Assignee: POLITECNICO DI MILANO, Milano (IT)

(21) Appl. No.: 18/700,355

(22) PCT Filed: Oct. 14, 2022
(86) PCT No.: PCT/IB2022/059846

§ 371 Date: Apr. 11, 2024

(30) Foreign Application Priority Data
Oct. 15, 2021 (IT) 102021000026456

(51) Int. Cl. B01J 8/06; B01J 8/00

(52) U.S. Cl. CPC B01J 8/067; B01J 8/009; B01J 2208/00415; B01J 2208/065

(57) ABSTRACT

An electrically heated chemical reactor is described for efficiently supplying reaction heat to the endothermic catalytic chemical processes as an alternative to or in combination with conventional heating methods.

### FIELD OF THE INVENTION

The present invention relates to an electrically heated chemical reactor for efficiently supplying reaction heat to the endothermic catalytic chemical processes as an alternative to or in combination with conventional heating methods.

### BACKGROUND ART

It is now well established that emissions into the atmosphere of anthropogenic greenhouse gases, in particular CO₂, are responsible for rapid climate change and damages resulting from extreme natural events, and methods for reducing these emissions as far as possible are therefore being explored in all areas of human activity.

Chemical plants are considered to be one of the industrial sectors where it is most difficult to achieve a drastic reduction in CO₂ emissions. A significant proportion of CO₂ emissions in this sector is associated with the need to supply heat to highly endothermic chemical processes.

For example, methane steam reforming units used in ammonia and methanol synthesis processes account for 1-2% of the global CO₂ emissions. Half of these emissions is associated with the combustion of natural gas and purge synthesis gas to supply an adequate reaction heat to support the production of syngas (a mixture of CO and H₂, possibly containing lower percentages of CH₄ and CO₂).

Other emerging processes based on endothermic reactions that require heat at high temperature and give rise to large CO₂ emissions include, for example, the water-gas shift reaction CO+H₂O→CO₂+H₂ (better known in the art by its abbreviation WGS), ammonia cracking and alkane dehydrogenation reactions.

In recent years, given the increasing availability of large amounts of electrical energy from low-carbon renewable sources, many studies have focused on electrically heated reactors; for example, the publication “Plugging in: What electrification can do for industry”, O. Roelofsen et al., Mckinsey & Company (2020), reports that it would already be technologically possible to replace up to half of industrial fuel consumption with electricity. In the field of chemical reactors, electric current can be converted into another form of energy which is then transformed locally into heat, in order to replace the combustion of fuel.

Among the possible choices, Joule heating (also known as resistive or ohmic) is the most direct and efficient approach.

A first example of an electrically heated chemical reactor is described in the article “Electrified methane reforming: A compact approach to greener industrial hydrogen production”, S. T. Wismann et al., Science 364, 756-759 (2019). This reactor consists of a Fe—Cr—Al alloy tube with an external diameter of 6.0 mm and a wall thickness of 0.35 mm; the tube is internally coated with a layer of porous zirconia, impregnated with nickel as a catalyst. The tube is connected to an electric current generator, and thanks to its very thin thickness it acts itself as an electrical resistance in the circuit. The proximity between the catalyst and the heat source is a key advantage of the system, as it minimises the problems associated with heat transfer. The system is able to reach temperatures above 900° C. with considerable power conversion efficiencies, in the order of 70%, and a specific power density of 12 MW/m³, a value higher than that of the conventional reactors (with burner) on an industrial scale. For each Nm³ of hydrogen produced with this technology an energy expenditure in the range 1.7-2 kWh is required.

Patent applications WO 2019-228795 A1, WO 2019-228796 A1, WO 2019-228797 A1 and WO 2019-228798 A1, all assigned to the company Haldor Topsøe A/S and with contents related to one another, describe a reactor consisting of a thermally and electrically insulated pressure-tight casing, inside which the active element of the system is arranged, consisting of a support in electrically conductive material coated with a layer of catalyst; the support is made of a material having electrical resistance (10⁻⁵-10⁻⁸ Ωm) sufficient to permit an efficient Joule heating (Fe—Cr—Al alloys are exemplified). The support can take on various geometries: the figures show channels with a square cross-section and parallel to the reactor axis, but the walls of the support can be shaped like plates, spirals or rods. According to the authors, the size of this active element structure (support plus catalyst) can be increased until a volume of the reactor of 10 m³ is obtained. The supports illustrated in these documents can be extruded or produced by 3D printing.

The article “Electrically driven SiC-based structured catalysts for intensified reforming processes”, S. Renda et al., Catalysis Today, available on line since Jul. 12, 2020 at the address https://doi.org/10.1016/j.cattod.2020.11.020, reports the study of a tubular reactor inserted in a ceramic tube thermally insulated from the environment, and which has internally a resistive heating element in a helical shape made of silicon carbide (coaxial with the tubular wall) covered with various commercial catalysts. The heating element has, along its entire length, an internal opening into which the reagent gas can be fed and flow. The results collected show that the system can reach relevant temperatures for operating under steam reforming or CO₂ reforming mode, and in the first it is able to approach thermodynamic equilibrium. However, this system also suffers from some limitations. In the proposed solution, the heating element occupies more than 70% of the volume of the reactor; the system has a small exchange area that can limit conversion under mass transfer regime; finally, a very limited amount of catalyst can be loaded considering thin catalyst layers due to possible limitations to the internal mass transfer. The thermal efficiency achieved in this system is also quite low, with a specific electrical power in the range of 4.5-5 kWh per Nm³ of H₂ produced.

The article “Experimental study of methane dry reforming in an electrically heated reactor”, M. Rieks et al., International Journal of Hydrogen Energy 40 (2015), 15940-15951, reports the results of the study of a reactor with a different configuration. In this case, the reactor consists of a high-temperature steel alloy tube with a tubular alumina chamber inside to prevent reactions from occurring on the steel walls. Two straight connectors parallel to the alumina wall electrically connect the heating element placed transversally to the reactor chamber. The heating element has the shape of a bent plate in order to obtain an essentially sinusoidal shape, is made of Fe—Cr—Al alloy and is coated with a catalyst based on Ni—La. This solution too allows temperatures of around 750° C. to be reached. This reactor has been tested by reforming methane with steam or with CO₂, but limited conversions have been achieved; this may be due to an unoptimised geometry that does not allow the effective contacting between gas and catalyst. No information is given in the article about the electrical input power, and therefore no conclusions can be drawn about the thermal efficiency of the process.

The articles “Enhancing CO₂ methanation over a metal foam structured catalyst by electric internal heating”, L. Dou et al., Chem. Commun., 56 (2020) 205 and “A compact catalytic foam reactor for decomposition of ammonia by the Joule-heating mechanism”, A. Badakhsh et al., Chemical Engineering Journal, 426 (2021) 130802, describe reactors consisting of a gas- and pressure-tight casing inside of which there is an active element formed by a catalyst support in the form of a metal foam.

In the first document (Dou et al.) the authors use a nickel foam coated with different active phases, including Ru and Co. The operation of a long and relatively thin foam support (20 cm long, 1 cm in diameter) connected to a direct current generator is demonstrated. This configuration allows the system to be heated rapidly and the electric current can be adjusted to control the temperature.

In the second document (Badakhsh et al.), a NiCrAl foam coated with a Ru catalyst and connected directly to some copper electrodes connected to a direct current generator is used. The system operates at temperatures around 500° C., where the system reaches almost 100% conversion for the exemplified reaction (ammonia cracking). The system, operated at a specific power of about 10 MW/m³, achieves thermal efficiencies in the range 5-25% throughout the experimental field investigated.

The solutions hitherto proposed for the electrification of the catalytic reactors still present some problems:
the solutions proposed in the article by Wismann et al. and in the patent applications by Haldor Topsøe A/S only allow a reduced ratio between the amount of catalyst and the internal volume of the reactor, a ratio that is notoriously low in the case of washcoated solutions of structured catalysts and which decreases as the diameter of the tube increases in the case examined by Wismann et al., so as to reach only a limited volumetric power density. Furthermore, the external (gas-solid) mass transfer resistances limit the overall productivity;
in general, the use of pellets of existing commercial catalysts is highly desirable. However, the direct Joule heating approaches described above require substantial modifications to the formulation and to the physical form of the catalyst. In fact, the systems of the prior art require a catalyst layer to be deposited on the surface of support materials starting from slurries of catalyst particles in a liquid phase generally comprising a main solvent and at least one particle binder before the system consolidation heat treatments (a set of techniques known in the field by the general definition “washcoating”). The procedure is well known in the technical literature, but it limits the amount of catalyst compared to packed beds of particles and entails the risk of detachment of the catalyst, in particular as a result of the thermal excursions to which the support is subjected and of the different coefficients of thermal expansion of the materials;
in the solutions described above, the electric current flows directly into the catalyst support and there is no insulating layer, with possible safety problems.

The object of the present invention is to make available a reactor for endothermic catalytic processes comprising a conductive thermal structure, electrically heated by indirect means, which serves as a support for a catalyst and which overcomes the drawbacks of the known systems, and in particular which allows to obtain excellent temperature uniformity, high efficiency, high power density and high reliability of the process that uses it.

### SUMMARY OF THE INVENTION

These objects are obtained according to the present invention, which in a first aspect thereof relates to a reactor for carrying out endothermic catalytic reactions, comprising:
at least one pressure-tight casing;
inside the casing, at least one resistive heating element connected to an external power supply;
a porous structure with communicating porosities consisting of a material with an intrinsic thermal conductivity of at least 40 W/m·K, preferably >100 W/m·K, in which the porosity is between 70 and 97%, preferably between 80 and 90% and the pore sizes are between 0.2 and 5 mm, preferably between 0.5 and 3 mm, which houses said at least one resistive heating element in direct thermal contact with said porous structure and which contains catalyst particles in its porosities or whose porosities have a ceramic coating that supports a catalytically active material;
an electric power supply sized to heat at least part of the reactor to the temperature required by the reaction to be carried out by passing an electric current through said at least one resistive heating element.

In alternative embodiments, the reactor of the invention may further comprise at least one other element selected among one or more further heating sources not necessarily of an electrical type external to the casing, a system for the separation of the reaction products integrated into the reactor, or a selective absorbent material packed in the internal cavities of the reactor.

In a second aspect thereof, the invention relates to a process comprising an endothermic catalytic chemical reaction carried out with the use of the reactor described above.

### BRIEF DESCRIPTION OF THE DRAWINGS

The invention will be described in the following with reference to the figures, in which:

FIG. 1 schematically shows a reactor of the invention with electrical heating only, made with heating means external to the casing of the reactor;

FIG. 2 schematically shows a reactor of the invention with electrical heating only, made with heating means internal to the casing of the reactor;

FIG. 3 schematically shows a reactor of the invention comprising further heating means in the form of a burner external to the casing of the reactor;

FIG. 4 schematically shows a reactor of the invention comprising further heating means in the form of resistive elements external to the casing of the reactor;

FIG. 5 schematically shows a reactor of the invention comprising further heating means in the form of a heating jacket with circulating fluid external to the casing of the reactor;

FIG. 6 schematically shows a reactor of the invention comprising particles of a sorbent in the porosities of the porous structure;

FIGS. 7 and 8 schematically show two alternative embodiments of a reactor of the invention comprising a permselective membrane for the continuous removal of a reaction product;

FIG. 9 schematically shows a specific reactor that has been employed for the realization of an experimental example of operation of the invention.

### DETAILED DESCRIPTION OF THE INVENTION

In the invention, unlike the systems of the prior art, the support structure of the catalyst is not itself the resistive heating element; the resistive heating of the catalyst is indirect, mediated by the presence of a material with high thermal conductivity; this decoupling between resistive heating material and support material avoids the safety problems that may occur with the systems of the prior art. The thermal coupling between the metal structure and the electrical resistances is fundamental for the efficacy of the system. In fact, the thermal contact between the metal structure and the electrical resistances allows the heat generated by the resistive element to be effectively distributed within the catalyst support.

In the following description, reference is always made to a single reactor, which can be of various types and take on different configurations, but of course in the practical embodiments of chemical plants systems consisting of two or more of the reactors described can be used, generally in parallel with each other, to increase the productivity of the plant.

The reactor of the invention, in its simplest configuration, comprises at least one pressure-tight casing within which there is a porous structure with communicating porosities which houses at least one resistive heating element and which contains in its porosities catalyst particles or whose porosities have a ceramic coating that supports a catalytically active material; the reactor is completed by an electric power supply for the Joule heating of the resistive heating element.

The casing may have various shapes, but the cylindrical geometry is the preferred one, which avoids the presence of dead corners in the wall in which reagents or products could stagnate; in the case of cylindrical symmetry, typically the inlet into the reactor of the reagents takes place through an inlet opening placed on one of the cylindrical bases, and the outflow of the products takes place through an opening placed on the opposite base.

The sizes of the reactor can vary within wide limits; typically, in the case of a cylindrical reactor, the external diameter of the casing can be between 0.02 and 4 m, and the length between 0.2 and 15 m.

The casing is made of metal materials ensuring pressure tightness. Only in the case of configurations in which external heating is also envisaged, special high temperature resistant steels are required. Steels that are useful for the purposes of the invention are those with low carbon content (steels with a carbon content lower than 1% by weight, nickel content in the range 15-25% by weight, chromium content in the range 20-25% by weight) which also allow to make the best use of the heating contribution from the outside.

The porous structure has communicating porosities, which means that there are no completely closed pores in the material and that there is a free path that connects any pair of pores of the structure. The porosity of this structure is between 70 and 97%, preferably between 80 and 90%; this value represents the ratio between the total volume of the pores and the geometric volume of the structure calculated taking into account its external sizes (sides and/or height and circumference in the case of cylindrical structure). The total pore volume can be measured with gravimetric measurements by comparing the density of the catalytic support and the density of the source material.

The pore sizes are between 0.2 and 5 mm. Pores in these sizes can be obtained, for example, with the methods of foaming, extrusion in the case of honeycomb structures produced by extrusion/turning or with the various techniques, such as selective casting, powder wire deposition or chemical binder deposition, which fall under the definition “additive manufacturing” or 3D printing.

The material with which the porous structure is made must have an intrinsic thermal conductivity of at least 40 W/m. K; respecting this first condition, the choice of the specific material depends on the reaction to be carried out with the reactor, because the temperature at which the reaction is to be carried out and any possible chemical incompatibilities with the reactive system and its products depend thereon; for example, aluminium has a high thermal conductivity but a melting temperature of 660° C., which might not be compatible with some reactions, or at least with the conditions under which these occur with high efficiency and yield. Useful materials for the realization of the porous structure are aluminium, copper, bronze, brass, nickel, high-conductive steels with low carbon content, silicon carbide, silicon dinitride.

The porous structure can simply house in its porosity pellets of catalysts. The pellets are loaded by pouring them from above into the porosities, whereby applying a vibration to the external shell of the reactor can be of help. It is also possible to preload cartridges with the pellets and then insert them gradually into the reactor. Alternatively, the surface of the porous structure can be coated with a ceramic layer, and a layer of catalyst material can be deposited thereon by washcoating.

The catalyst material that is housed within the pores of the structure depends on the chemical reaction to be carried out in the reactor. Examples of typical endothermic reactions that can be carried out in a reactor of the invention, with their characteristic catalysts, are reported below:
A) steam reforming of natural gas/biogas: for example using catalysts based on Ni or Rh on dispersing ceramic supports such as alumina and magnesium/aluminates;
B) ammonia cracking: for example using catalysts based on Fe, Ru, Ni on alumina, titania, SiO₂;
C) dehydrogenation of alkanes: for example using catalysts based on Pt, Sn on dispersing ceramic supports;
D) reverse water shift reaction (also known as RWGS): for example using catalysts based on Ni, Fe, Pt, Cu on dispersing ceramic supports such as alumina.

Inside the porous structure, and in close contact therewith, there is also at least one resistive heating element, connected to an external electric power supply, which can be in direct or alternating current. Resistive heating elements are well known in the technology industry and are widely commercially available; examples of such heating elements are resistances made of Kanthal® (a trademark owned by Sandvik Intellectual Property AB, Sweden) or silicon carbide resistors. In the present invention, however, it is necessary for the resistive element to be covered with a thin layer of mineral oxide that provides electrical insulation between the resistance and an external metal sheath (high temperature resistant steel). This ensures an electrical insulation between the resistance and the catalytic support without compromising the thermal contact thereof. The resistive element must allow a power dissipation (also called surface load) in the range 10-1000 kW/m² of external surface, preferably >100 kW/m².

By employing the materials and by adopting the conditions and characteristics described above, it is possible to construct reactors of the invention in various configurations, described below with reference to the figures; in the figures, an equal number corresponds to an equal element.

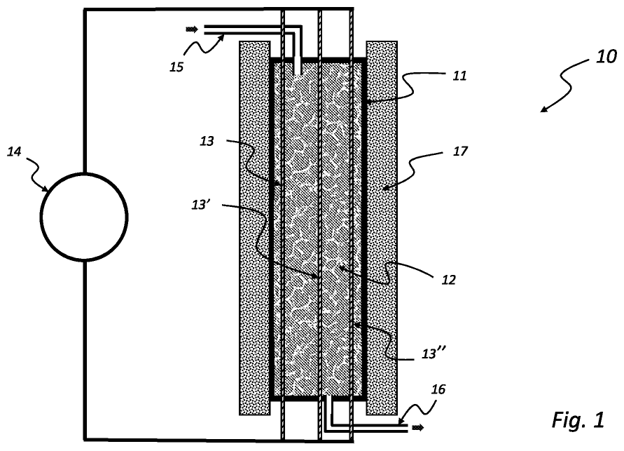

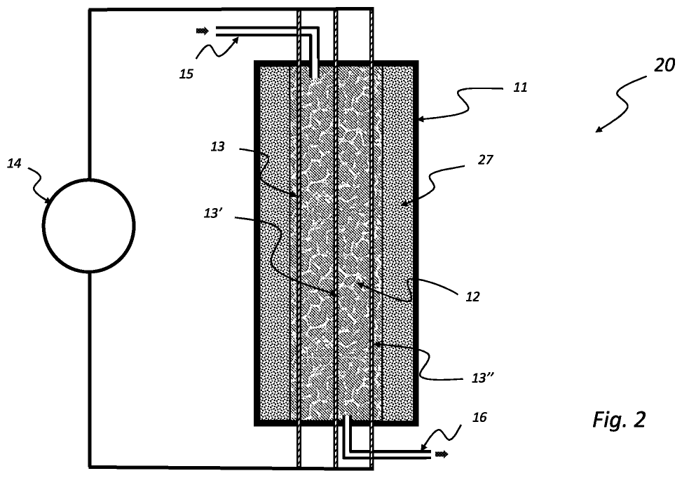

In the simplest embodiment of the invention, the heating of the reactor is only electrical. This condition can be achieved with two alternative modes, illustrated in FIGS. 1 and 2.

The reactor of FIG. 1, reactor 10, is formed by the casing 11 inside which there is the porous structure 12, in which resistive heating elements 13, 13′ and 13″ are housed (in the example in the figure three of them are shown, but there could be only one, two or more of three), connected to a current source 14. The porous structure 12 houses, in the form of pellets in its porosities or in the form of deposit on the surface of the porosities themselves, a catalytic material (not shown in the figure).

At the two opposite ends of the casing 11 there are a line 15 for the inlet of the reagent gases, and a line 16 for the discharge of the gaseous products of the reaction. In this embodiment of the invention, the reactor is inserted into a jacket 17 made of a thermal insulating material, to minimize heat dispersions to the outside and thus maximize the system yield.

In the reactor of FIG. 2, reactor 20, there is a layer of insulating (refractory) material 27 inside the casing 11 which has the purpose of thermally insulating the reactor and maintaining the casing at a temperature lower than the reaction temperature: with this configuration it is possible to use for the realization of the casing 11 materials resistant to temperatures lower than the configuration described above with reference to FIG. 1, for example carbon steels.

With the reactors of FIGS. 1 and 2, wherein the heating of the system is only by the one or more heating elements in direct contact with the porous structure, it is possible to achieve power densities greater than 10 MW/m³ when the volume of the heating elements is in the range of 10-40% of the volume of the casing 11. These reactors can be effectively used for any of the reactions A-D mentioned above.

Other possible reactors of the invention combine heating by the heating elements of the reactor 10 with other heating methods that are conventionally applied for chemical processes. In particular, in the reactors of the present invention, the electrical heating due to the elements of type 13, 13′ and 13″, can be coupled for example to a heating from the outside by means of burners, external electrical resistances or a heating fluid jacket.

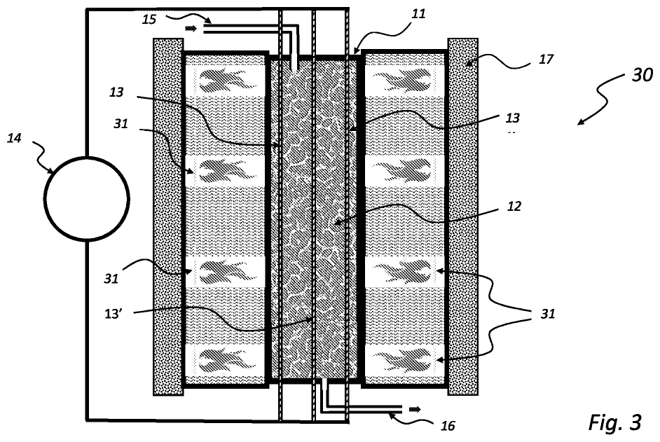

The first of these possibilities is illustrated in FIG. 3. The reactor, 30, comprises the same elements 11 to 17 described with reference to the reactor 10, and one or more burners 31 arranged so as to uniformly heat one or more reactors. The reactor 30 allows to exploit the synergy of the two heating systems, being able to reach higher power densities than the only electrified system and allows to modify the primary energy source used for heating depending on the economic conditions and the availability of renewable energy. This configuration is extremely interesting in the case of steam methane reforming, which is characterised by the highest requirement for specific thermal power among the reactions in which the reactors of the present invention can be employed.

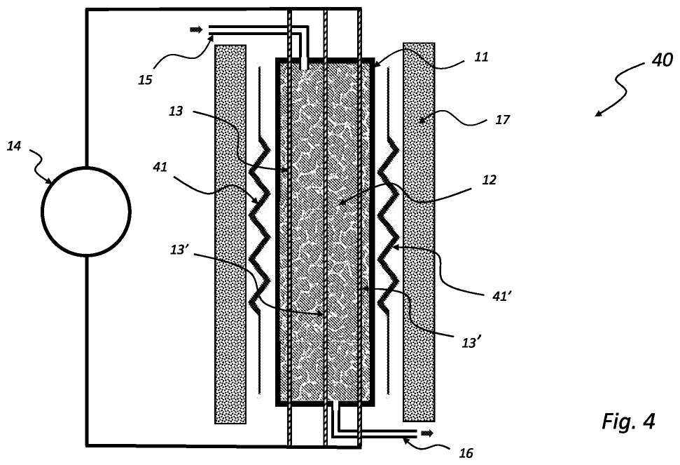

FIG. 4 shows another possible reactor of the invention, 40, wherein the heating is due to the combination of the heating elements 13, 13′ and 13″ and of external resistive heating elements. Also this reactor comprises the elements 11 to 17 described above, and further resistive elements distributed around the casing (represented in the figure as elements 41 and 41′, but typically they are more than 2, for example 4 or 6), which can be powered by the same current source 14 that powers the elements 13, 13′ and 13″ or a different source if it is necessary to modulate the voltage at the ends of the resistors differently or if the resistors have unmatched electrical characteristics; in FIG. 4 the connection of the elements 41, 41′ to the current source 14 or to a different one is not shown. The thermal insulation jacket 17 avoids the outward dispersion of heat provided by the elements 41 and 41′.

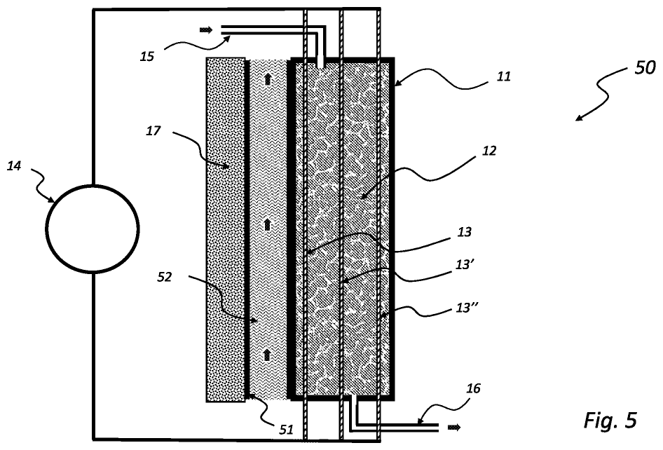

FIG. 5 shows a further possible hybrid heating reactor configuration, wherein a portion of the heat required for the reaction is provided by a fluid. This reactor, 50, comprises the elements 11 to 17 and a jacket 51 around the casing 11 in which a heating fluid 52 flows. In the figure, the jacket 51 is schematically represented as a simple toroidal chamber, but it could be a coil winding, preferably with narrow turns (turns in contact with each other) around the casing; moreover, for simplicity of representation the jacket 51 is shown only on one side of the reactor 50, but this completely surrounds it; the arrows represent the flow direction of the fluid 52 inside the jacket. The fluid may circulate in the jacket 51 in equicurrent or counter-current or cross-flow or a combination of the foregoing with respect to the direction of the gases in the reactor. This system can be used for applications operating at temperatures preferably below 500° C.

The reactors of the invention can also integrate selective absorption or permeation systems for some of the gases involved in the reaction, in particular the products, so as to shift the reaction equilibrium towards the latter by removing them in situ; this solution also makes it possible to avoid separation units downstream of the reactor if necessary. In the present description and in the claims, for simplicity, the terms “absorption”, “absorbent material”, “sorbent” and related terms are used, to refer both to chemical absorption, which implies the formation of chemical bonds between the absorbent material and absorbed compounds, and to the phenomenon normally referred to as “adsorption”, which consists in the fixing of molecules of a fluid (typically a gas or steam) on a solid surface following both chemical and physical interactions, such as electrostatic attractions, Van der Waals forces and the like.

These possibilities are illustrated below with reference, as a basic reactor, to the simplest possible reactor among those described above, namely the reactor 10; however, it will be completely evident to those skilled in the art that the integration of selective absorption and/or permeation systems is also possible with each of the other reactors 20, 30, 40 or 50.

Materials for the selective absorption of reaction products useful for the purposes of the invention are for example calcium oxide or magnesium oxide for the absorption of CO₂, zeolites for the absorption of water and CO₂, MOF (Metal-Organic Frameworks) for the adsorption of water and CO₂.

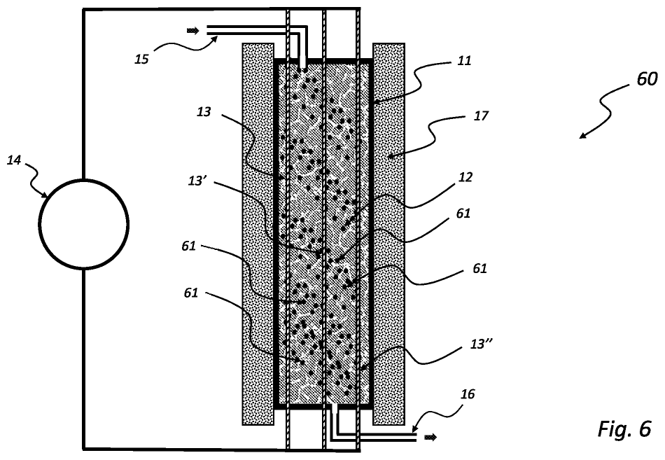

The materials for the selective absorption of reaction products may be added alone in the porosities of the structure 12, if the catalyst is deposited on the surfaces of its pores, or in the form of a mechanical mixture of sorbent material and catalyst (in appropriate proportions) if the catalyst is also in the form of pellets housed in said porosities. FIG. 6 shows a reactor, 60, comprising in the porosity of the structure 12 the particles of sorbent material, cumulatively referred to as element 61.

The sorbent material must be regenerated periodically; this can be done using the procedures well known to those skilled in the art by the designations “Pressure Swing Adsorption” and/or “Temperature Swing Adsorption” or by their acronyms PSA and TSA.

During regeneration, the desorbed products can be stored in separate streams. For example, this configuration may be implemented for methane steam reforming using a CO₂ selective sorbent material, or for RWGS reactors, where water selective sorbent materials may be used.

The use of permselective membranes is particularly relevant in case the produced gas to be removed is hydrogen; materials suitable for the production of permselective membranes for hydrogen are above all noble metals, in particular palladium.

The use of permselective membranes for hydrogen allows to improve the yield in particular of the reactions A), B) and C) reported above.

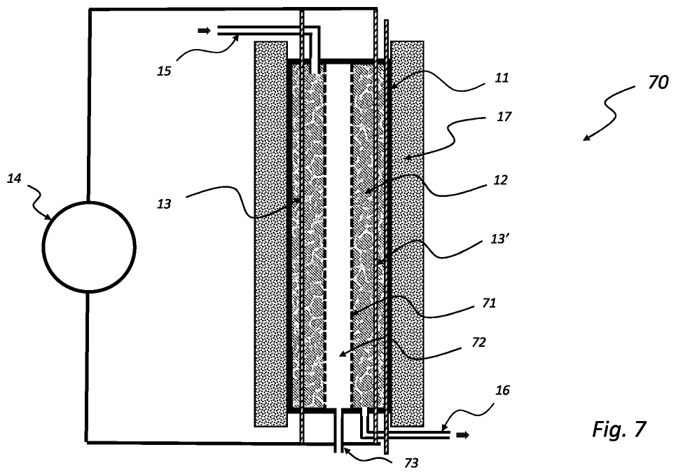

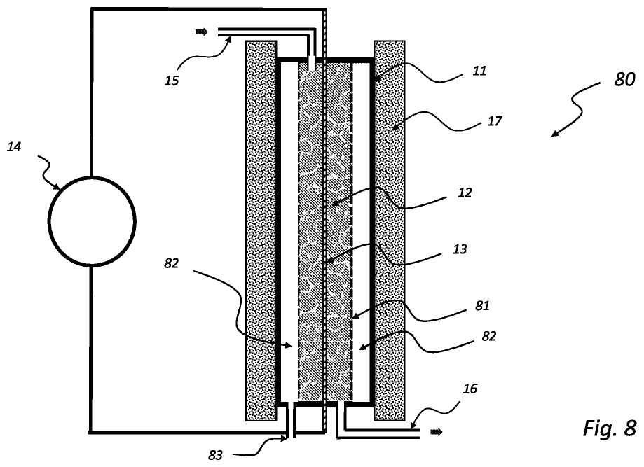

Two possible embodiments of a reactor of the invention integrating a permselective membrane are shown schematically in FIGS. 7 and 8. In the first case, reactor 70, the membrane 71 is a cylindrical wall coaxial to the reactor and arranged in the centre of the same; the reactor provides in this case for the presence of a further outlet line, 73, in correspondence of one of its two ends and the central chamber 72 defined by the membrane 71, for the outflow from the reaction zone (corresponding to the volume occupied by the structure 12) of the gas permeated from the system. In the second case, reactor 80, the membrane 81 is still a cylindrical wall coaxial to the reactor, but arranged in the peripheral zone of the same, and correspondingly the outlet opening 82 of the permeated gas will be positioned at the edge of the reactor. In both cases, the porous structure 12 must be suitably shaped during production to allow the membrane 71 or 81 to be housed in the reaction chamber defined by the casing 11.

The first solution (reactor 70) is similar to the configurations already proposed for membrane reactors, while the second (reactor 80) is made possible by the possibility of heating the reactor from the centre. This solution allows, with the same volume of the permeated side, to increase the surface of the membrane and therefore the separation efficiency.

In the case of hybrid heating systems (reactors 30, 40 and 50), the membrane can only be positioned in the centre of the pressure mantle, since the external side of the pressure mantle is the external heat exchange area, regardless of the secondary heating method adopted.

According to the present invention, it is also possible to realize reactors that adopt both solutions described above for the selective removal of some of the gases produced in the reactions, i.e., reactors that include both materials for the selective absorption of reaction products, as described with reference to reactor 60, and permselective membranes, as described with reference to reactors 70 and 80.

The invention will be further illustrated by the following examples.

### Example 1

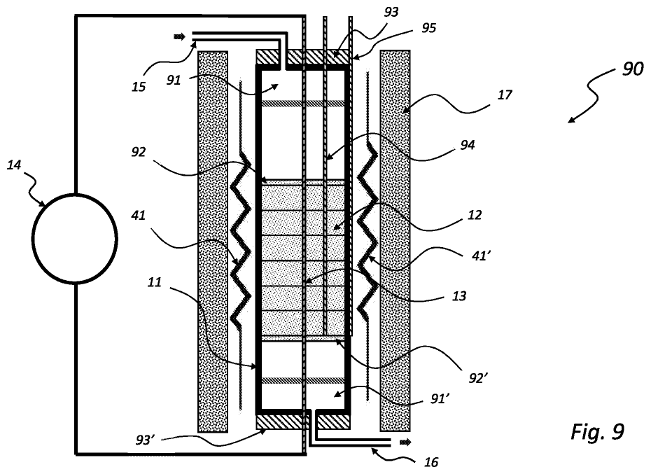

This example relates to a methane steam reforming reaction test carried out with a reactor of the invention having the configuration shown in FIG. 9.

In this reactor, 90, the porous structure 12 does not occupy the entire internal space of the pressure-tight casing 11, leaving empty zones 91 and 91′ at the head and at the tail, i.e. in correspondence of the two ends of the reactor; the porous structure 12 is separated from the empty zones 91 and 91′ through two metal porous septa 92 and 92′. The casing 11 is made of high temperature resistant steel and has an internal diameter of 29.5 mm, an external diameter of 32 mm and a length of 70 mm. There are two flanges (93, 93′) at the head and at the tail to allow the supply and the discharge of gases, the assembly of the heating element with compression tightness and a well for temperature measurement by means of a thermocouple inserted in a sheath, 94.

On the external surface of the shell there is a welded metal sheath 95 in which a thermocouple runs to monitor the external temperature of the casing 11. Inside the casing 11 there is only one heating element 13 of external diameter equal to 4 mm in the centre of the reactor, connected to an external electrical energy generator (14) DC where the voltage is regulated in order to obtain the required power; the heating element is formed by a metal wire, mineral oxide powder and an electrically insulated metal shell. In addition, this element is designed to provide a maximum power equal to 200 W in a 15 cm long zone (in correspondence of the porous septa 92 and 92′) and two cold zones at the head and at the tail. The maximum surface load of the element is therefore equal to 10 W/cm² (100 kW/m²) but similar elements with declared surface loads equal to 50 W/cm² (500 kW/m²) are commercially available. There are also further heating elements of the resistance type, 41 and 41′, between the external surface of the casing 11 and the insulating material 17.

Twelve discs of structure 12 each 1.25 cm thick, consisting of open-cell Cu foams with 1 mm pores and a vacuum grade equal to 0.88, were placed inside the casing 11. The discs were drilled with a 4 mm hole so as to ensure good contact with the heating element 13 and the casing 11 to improve heat transfer. A second hole with a diameter of 3.2 mm was made at r/2 to allow the insertion into the reactor of the sheath 94 containing a thermocouple for the temperature measurement of the system.

The catalyst consists of granules of a Rh/Al₂O₃ formulation, which is very active for methane steam reforming. The size of the catalyst granules is adjusted to allow a good filling of the structure 12 and is equal to 0.6 mm. The catalyst was diluted with pellets of the same material (alumina) and same particle size in catalyst/diluent weight ratio equal to 1/3.5.

The last 6 foam discs were filled with the mechanical diluent catalyst mixture, loading 7.35 grams of Rh-based catalyst on alumina. Metal filters were inserted to separate and contain the catalyst. The remaining portion of the hot zone was placed into contact with an empty copper foam. The catalyst particles are loaded inside the cavities of the structure 12 obtaining a degree of filling (referring to the porosities remaining in the system) equal to 50%.

Additional heat sources are present outside the pressure shell, in particular a three-zone furnace with eight radially arranged resistances was used. The furnace is already provided with a layer of thermal insulation to minimize thermal losses.

The gas supplied through the opening 15 is composed of a mixture of water steam and methane with a steam/methane volume/volume (v/v) ratio equal to 4 and a spatial speed equal to 30,000 NL/h per kg catalyst (NL/h/kg cat).

The system can be operated:
using only the internal heating element
using only the external heating element
with any combination of the two heat sources.

The tests were performed both by keeping the internal heating element switched off and by using the internal heating element and the furnace simultaneously.

The results in terms of gas outlet temperature, methane conversion and hydrogen productivity per kg of catalyst are reported in Table 1.

TABLE 1

| | Internal heating | Outlet | Methane | H₂ |
|---|---|---|---|---|
| T furnace | element power | T | conversion | productivity |
| (° C.) | (W) | (° C.) | (%) | (Nm³/h/kg cat) |
| 600 | 0 | 548 | 71.1 | 13.29 |
| 600 | 75 | 583 | 81 | 18.10 |
| 600 | 150 | 613 | 86.8 | 19.56 |
| 650 | 0 | 612 | 85.9 | 19.52 |
| 650 | 75 | 643 | 92.0 | 20.44 |
| 650 | 150 | 666 | 94.0 | 20.78 |
| 700 | 0 | 664 | 95.2 | 20.76 |
| 700 | 75 | 700 | 99.5 | 20.94 |
| 700 | 150 | 731 | 99.0 | 20.92 |

It can be seen that the addition of power through the internal heating element allows to increase the temperature of the outlet gas, the methane conversion and the hydrogen productivity of the system, until the complete conversion is achieved.

This example is not optimized to obtain high specific powers or high thermal efficiencies, but it is to be considered a proof-of-concept in view of the realization of similar units on semi-industrial size.

### Example 2

With reference to the configuration proposed in FIG. 1 the theoretical design of a system with the following characteristics was considered:
reactor diameter 10 cm
reactor length 1 m
specific power (referred to volume of the reactor) 10 MW/m³.

To obtain the required electrical power, the sizing was made comprising the number of heating elements necessary to supply the design power based on the diameter of the heating element and on the maximum permissible surface load. Assuming heating elements with a diameter of 7.5 mm and a surface load of 400 kW/m² are used, it is necessary to use nine elements to supply the target power of the reactor. These elements occupy 16% of the volume of the unit. For the same specific load, it is necessary to mount more elements with a smaller diameter, which at the same time occupy a smaller fraction of the volume of the reactor. The increase in the surface load of the element allows to significantly reduce the number of necessary elements.

If the adoption of copper supports identical to the case of Example 1 (foams) and of a catalyst with the same particle size is taken into consideration, the foams occupy 12% of the remaining volume and in the porosities the catalyst is packed with a vacuum degree equal to 50%. It follows that in the unit described here, assuming a density of the catalyst equal to 1080 kg/m³, it is possible to load 3.13 kg of catalyst.

Thermodynamic simulations were then carried out to understand the possible performance under industrial-relevant operating conditions for the methane steam reforming reaction. It was considered that the inlet supply consists of methane and water with a ¼ v/v ratio and the inlet temperature is equal to 500° C. It has been assumed that the reactor operates under conditions of thermodynamic equilibrium and that the thermal dissipation is equal to 5% of the electrical power supplied by the heating elements. The equilibrium condition is consistent with the performance of rhodium-based catalysts operated at the same spatial speeds. The results of the simulation are shown in Table 2.

TABLE 2

| GHSV | | | Conversion | | Produced |
|---|---|---|---|---|---|
| (NL/h/kg | GHSV | Pressure | CH₄ | T out | equivalent H₂ |
| cat) | (1/h) | (ata) | (—) | (° C.) | (Nm³/h) |
| 37525 | 15000 | 1 | 0.986 | 701.0 | 92.93 |
| 33772 | 13500 | 1 | 0.998 | 786.7 | 84.65 |
| 30020 | 12000 | 1 | 0.999 | 904.8 | 75.35 |
| 37525 | 15000 | 15 | 0.860 | 798.1 | 81.06 |
| 33772 | 13500 | 15 | 0.928 | 841.0 | 78.75 |
| 30020 | 12000 | 15 | 0.982 | 918.7 | 74.01 |
| 37525 | 15000 | 30 | 0.812 | 835.6 | 76.57 |
| 33772 | 13500 | 30 | 0.886 | 874.9 | 75.12 |
| 30020 | 12000 | 30 | 0.957 | 938.6 | 72.12 |

For the measurement of the hydrogen yield, the hydrogen produced was considered by assuming a WGS reactor stage capable of converting the residual fraction of CO in the reaction products into additional hydrogen and CO₂.

It is evident that with this reactor configuration it is possible to operate the system at higher spatial speeds than conventional reformers (up to 15000 h⁻¹ compared to 4000-6000 h⁻¹). The spatial speed referred to the mass of catalyst is in the same range as that used experimentally where it is evident how the system reaches thermodynamic equilibrium. Simulations were carried out at three different spatial speeds considering the atmospheric pressure system, 15 atmospheres and 30 atmospheres. The increase in spatial speed, with equal thermal power, leads to a reduction in the gas outlet temperature but with limited effects on the conversion of methane at low pressure. In this operating range, productivity rises linearly with spatial speed.

In the case of simulations at higher pressure, due to the thermodynamic equilibrium constraint, the conversion at the same spatial speed is lower and, as a consequence, the reactor outlet temperature is higher. Therefore, a reduction in hydrogen productivity is observed at the same spatial speed and the increase in productivity increases more modestly than the spatial speed. However, it is demonstrated that the system proposed here can operate at spatial speeds 2-3 times higher than current industrial practice.

1. A reactor for carrying out endothermic catalytic reactions, comprising:
a pressure-tight casing, at the two opposite ends of which there are a line for the inlet of the reagent gases and a line for the discharge of the gaseous products of the reaction, inside the casing, at least one resistive heating element connected to an external power supply;
a porous structure with communicating porosities consisting of a material with an intrinsic thermal conductivity of at least 40 W/m·K, in which the porosity is between 70 and 97% and the pore sizes are between 0.2 and 5 mm, which houses said at least one resistive heating element in direct thermal contact with said porous structure, and which contains catalyst particles in its porosities or whose porosities have a ceramic coating that supports a catalytically active material; and
an electric power supply sized to heat at least part of the reactor to the temperature required by the reaction to be carried out by passing an electric current through said at least one resistive heating element.

2. The reactor according to claim 1, wherein the material constituting said porous structure has an intrinsic thermal conductivity greater than 100 W/m·K, said porosity is between 80 and 90% and said pore sizes are between 0.5 and 3 mm.

3. The reactor according to claim 1, wherein said casing has cylindrical geometry.

4. The reactor according to claim 3, wherein said casing has an external diameter between 0.02 and 4 m and a length between 0.2 and 15 m.

5. The reactor according to claim 1, wherein said casing is made of a steel with a carbon content lower than 1% by weight, a nickel content in the range 15-25% by weight, and a chromium content in the range 20-25% by weight.

6. The reactor according to claim 1, wherein said porous structure is made of a material selected from aluminium, copper, bronze, brass, nickel, high-conductive steels with low carbon content, silicon carbide and silicon dinitride.

7. The reactor according to claim 1, wherein said catalyst is selected from:
a catalyst based on Ni or Rh on a dispersing ceramic support selected from alumina and magnesium/aluminates;
a catalyst based on Fe, Ru or Ni on a support selected from alumina, titania or silica;
a catalyst based on Pt or Sn on a dispersing ceramic support;
a catalyst based on Ni, Fe, Pt or Cu on an alumina support.

8. The reactor according to claim 1, wherein said at least one resistive heating element is a resistance made of Kanthal® or silicon carbide, covered with a thin layer of electrically insulating oxide and housed in an external metal sheath.

9. The reactor according to claim 8, wherein said at least one resistive heating element has a power dissipation between 10 and 1000 kW/m².

10. The reactor according to claim 1, inserted in a jacket of a thermally insulating material.

11. The reactor according to claim 1, inside which there is a layer of thermally insulating material in contact with the internal wall of said casing.

12. The reactor according to claim 10, further comprising, between said casing and said jacket of a thermally insulating material, one or more burners symmetrically arranged with respect to the length of the reactor or in a configuration with burners placed in the highest part of the furnace and the reactor in contact with the hot fumes.

13. The reactor according to claim 10, further comprising, between said casing and said jacket of a thermally insulating material, further resistive heating elements distributed around the casing connected to the same current source which supplies said at least one resistive heating element arranged inside the casing, or to a different current source.

14. The reactor according to claim 10, further comprising, between said casing and said jacket of a thermally insulating material, a jacket in which a heating fluid flows, in equicurrent, counter-current, in cross-flow or a combination thereof with respect to the direction of motion of the gases in the reactor.

15. The reactor according to claim 14, wherein said jacket in which a heating fluid flows is in the form of a toroidal chamber or a coil winding around the casing.

16. The reactor according to claim 1 further comprising, in the pores of said porous structure, at least one material for the selective absorption of products of the reaction carried out in the reactor.

17. The reactor according to claim 16, wherein said material for the selective absorption of reaction products is selected from calcium oxide or magnesium oxide for the absorption of CO₂, zeolites for the absorption of water and CO₂, and MOF (Metal-Organic Frameworks) for the adsorption of water and CO₂.

18. The reactor according to claim 1, further comprising a permselective membrane for one of the gases produced in the reaction carried out in the reactor.

19. The reactor according to claim 18, wherein said gas is hydrogen and the membrane is made of a noble metal.

20. The reactor according to claim 19, wherein said noble metal is palladium.

21. The reactor according to claim 18, wherein said permselective membrane is a cylindrical wall coaxial to the reactor arranged in the centre of the same, and the reactor comprises a further outlet line for the outflow from the system of the permeated gas from the reaction zone, in correspondence of one of its two ends and of a central chamber defined by the membrane.

22. The reactor according to claim 18, wherein said permselective membrane is a cylindrical wall coaxial to the reactor arranged in the peripheral zone of the same, and the reactor comprises a further outlet line for the outflow from the system of the permeated gas from the reaction zone, in correspondence of one of its two ends and of a chamber having a circular crown section defined by the membrane at the external edge of the reactor.

23. A system consisting of two or more reactors of claim 1.

24. The system according to claim 23, wherein said two or more reactors are of the same type.

25. The system according to claim 23, wherein said two or more reactors are arranged in parallel in a chemical plant.

26. An endothermic reaction carried out in a reactor of claim 1, selected from:
A) steam reforming of natural gas/biogas, using in the reactor a catalyst based on Ni or Rh on a dispersing ceramic support selected from alumina and magnesium/aluminates;
B) ammonia cracking, using in the reactor a catalyst based on Fe, Ru or Ni on a support selected from alumina, titania or silica;
C) dehydrogenation of alkanes, using in the reactor a catalyst based on Pt or Sn on a dispersing ceramic support;
D) reverse water gas shift (RWGS), using in the reactor a catalyst based on Ni, Fe, Pt or Cu on an alumina support.
